(19) United States
(12) Patent Application Publication
(10) Pub. No.: US 2008/0168742 A1
(43) Pub. Date: Jul. 17, 2008

(54) Floor Covering Strips Or Slabs, Production Method Thereof And Production Facility Used For Same

(75) Inventors: Thierry Miclo, Schiltigheim (FR); Jean-Jacques Strub, Strasbourg (FR); Claude Campo, Strasbourg (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ESPACE PRODUCTION INTERNATIONAL, EPI, Societe anonyme, Marlenheim (FR)

(21) Appl. No.: 11/913,949

(22) PCT Filed: May 10, 2006
(86) PCT No.: PCT/FR06/50428

§ 371 Date: Nov. 9, 2007

(30) Foreign Application Priority Data
May 10, 2005 (FR) 0551206
Jul. 12, 2005 (FR) 0552160

(51) Int. Cl. E04F 15/10; B44C 5/00

(52) U.S. Cl. 52/745.19; 52/746.1

(57) ABSTRACT

The invention relates to a method for producing floor covering strips or slabs (1) comprising support panels (2) which are covered with a decorative layer (3) by means of surfacing. The invention is characterised in that it comprises the following steps consisting in: applying glue to ail or part of at least one face (5) of a support panel (2), applying a decorative sheet (7) to the glued face (5) of the support panel (2), in particular by means of calendering; and cutting the panel (2) into floor covering strips and/or slabs (1). The invention also relates to a facility that is used to implement said method and to a floor covering strip thus produced.

### BACKGROUND OF THE INVENTION

(1) Field of the Invention

The invention relates to a method for producing floor-covering boards or slabs from support panels coated with a decorative layer by means of surfacing. The invention also relates to a plant for implementing the method, as well as to a floor covering comprised of boards or slabs produced by such a method.

(2) Description of the Prior Art

Within the framework of the state of the art, shown for example in US-2004/0045940, are known in particular floor coverings, referred to as laminated floor coverings, comprised of a plurality of boards which are assembled by gluing or mechanical encasement.

These boards are cut from laminated panels coated on the upper face with a decorative layer.

In this respect, such panels include a wooden or wood-containing core, for example of the type HDF or MDF, i.e. made from wood fibres agglomerated in a press and with addition of a binder such as a resin. This core of the panel can also be made out of synthetic material, even of recycled materials.

Furthermore, this core of a laminated panel receives, on its upper face, a decorative coating consisting of a sheet on which is printed a decoration and impregnated with a polymerizable resin, such as for example melamine or the like. Similarly, on this decorative coating is applied an overlay in the form of a cellulose sheet impregnated with resin and containing a filler, such as aluminium oxide, which has the peculiarity of imparting to the floor covering a better abrasion resistance. On the lower face of such laminated panels is applied a layer, referred to as counterbalance, in order to balance the stresses in the panel. It usually consists of a simple sheet of kraft paper, also impregnated with resin.

These various layers a laminated panel is comprised of: overlay, decorative coating, core and counterbalance; are hot pressed in order to be bonded to each other. Therefore, the panels have to be cooled down before carrying out their machining in order to cut them into boards or slabs aimed at making the floor covering.

Thus, at the exit of the press, these melamine-coated panels are at a temperature in the range of 100° C. and for their cooling they are stored until stabilization of their temperature, which can require some time, in particular when these panels are stored by piling-up immediately after the pressing operation.

As a matter of fact, such a cooling over an extended period can generate stresses at the level of these panels, as is explained in particular in EP-0,978,359. Furthermore, the longer the stabilization time of the panels, the more it is necessary to have large storage spaces, which results into a lesser production flexibility and reactivity.

It should also be noted that such storage spaces are necessarily enclosures with a controlled environment and requiring particular equipment, which further increases the cost of the surface reserved for the panels in progress of cooling.

In addition, the hot-pressing operation itself gives rise to a number of problems. In particular, as has been explained above, the core of the panel can be made of fibres or particles, in particular of wood or other materials, agglomerated using a synthetic binder. Under the action of heat, such materials can have various behaviours. In particular, this can result into deformations resulting into curling or banana effects for the boards the floor covering is comprised of.

Moreover, it necessarily results into phenomena of differences in expansion between the materials, which are very difficult to be controlled and which result, as a matter of fact, into the necessity of subjecting the panels to an extended period of stabilization at the end.

Likewise, during the impregnation of the melamine-coated paper, the latter undergoes an expansion compensated for under the action of heat, which, depending on the type of printed decoration, can disturb the decorative aspect of the floor covering one wishes to achieve.

In addition, it should be noted that the levels of brightness that can be achieved for a laminated floor covering are limited. This degree of brightness, as well as the effects of embossing, results from the metal sheets the press is provided with. Thus, each time one wishes to change this degree of brightness of the panels produced, one should replace the metal sheet aimed at entering into contact with the upper face of these panels, knowing, in addition, that such metal sheets are subjected to wear and that they must be periodically replaced or surface-treated.

As has been mentioned above, from this metal sheet a press is coated with also result the embossing effects sought. In particular, some laminated floor coverings include, as decorative coating, an imitation of tiling, which requires a difference in embossing and aspect between the tiles and the seams delimiting same. The difficulties in achieving these various surface conditions, combined with the phenomenon of expansion of the decorative melamine-coated paper, leads to a production of panels with a high rate of discards.

### SUMMARY OF THE INVENTION

The present invention pretends to provide a solution for all the above-mentioned problems. To this end, it was necessary, in a first inventive step, to depart from a prejudice with the specialist in the art, according to which only the stratification solution allows achieving a floor covering with sufficient mechanical strength for such an application.

The solution according to the invention results, in addition, from a complete renewal of the production method for this type of laminated floor covering. In particular, within the framework of a second inventive step was sought a solution avoiding any heat supply during the surfacing of the panels. In particular, according to the inventive method, a panel coated with a decorative layer can immediately be machined for producing floor-covering boards.

Advantageously, the method according to the invention permits designing a plant for its implementation including, immediately downstream, a unit for producing panels, a cutting and machining unit for cutting these panels into floor-covering boards or slabs.

The advantages resulting from the method according to the invention reside in that it is possible to achieve perfectly stable floor-covering boards that are not likely to be deformed due to internal stresses resulting from the surfacing operations on the panels from which these boards proceed.

In addition, the method according to the invention avoids any intermediate storage for stabilization of the panels or any cooling unit whatsoever.

Another advantage resulting from this invention resides in that the core of a panel can be made of any type of material, even of materials that do not withstand temperatures as high as those implemented in a usual stratification process.

Moreover, since traditional coating techniques, such as calendering, are used for applying the decorative coating, the support panels are not necessarily subjected to such high pressures that could so far limit the nature of the materials the core of these panels is made of.

Thus, the invention relates to a production method for floor-covering boards or slabs from support panels coated with a decorative layer by surfacing, wherein:
glue is applied on all or part of at least one face of a support panel;
a decorative sheet is applied, in particular by calendering, on said glued face of the support panel;
said panel is cut into floor-covering boards and/or slabs.

According to the invention, glue is applied on all or part of each face of the support panel for applying, in particular by calendering, a decorative sheet on one of the faces and a counterbalance on the opposite face.

In particular, according to the invention, urea-resin glue is applied on at least one of the faces of the support panel, in particular the face aimed at receiving the decorative sheet.

According to another characteristic of the invention, the decorative sheet is coated, on its decorative face, with at least one layer of varnish containing aluminium-oxide filler.

As regards the plant allowing implementing the method according to the invention, it includes a unit for surfacing the panels and a cutting and machining unit for cutting said surface-treated panels into floor-covering boards and/or slabs, as well as means for transferring the panels between said surfacing unit and the cutting and machining unit.

### BRIEF DESCRIPTION OF THE DRAWING

The present invention will be better understood when reading the following description referring to an exemplary embodiment and with reference to the attached drawing, in which:

FIG. 1 is a schematic cross-sectional view of a floor-covering board according to the invention;

and FIG. 2 schematically shows the method for producing such a board.

### DETAILED DESCRIPTION OF THE PREFERRED EMBODIMENTS

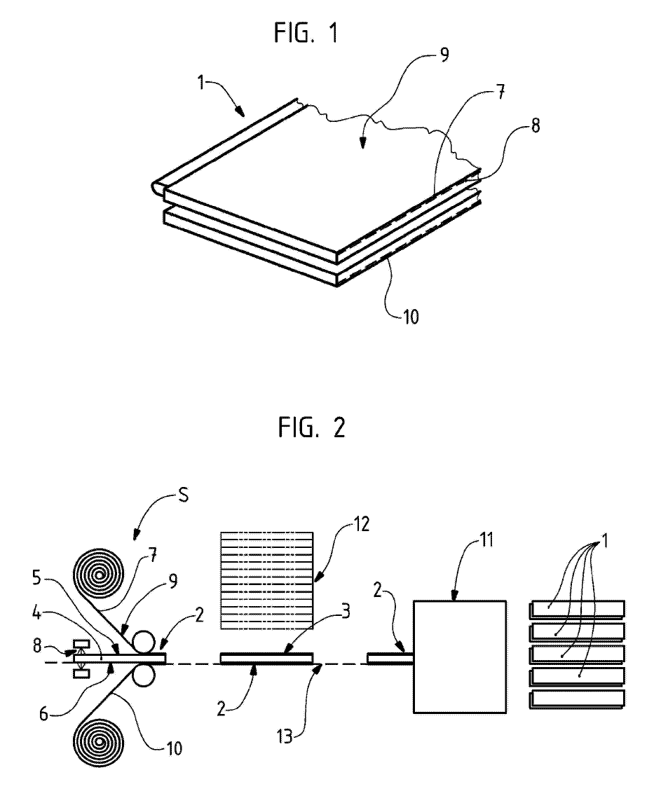

As can be seen in FIG. 1, the present invention relates to the field of the floor coverings. Such a floor covering is comprised of boards 1 or slabs derived from panels 2 (visible in the diagram of FIG. 2) coated with a decorative layer 3 by surfacing.

It should be noted that in the following description the term “board” is used in a generic way, in that, though such a board is shown with a rectangular shape in FIG. 1, it could also have a square shape in order to be more similar to a slab.

Turning back to the panel 2 from which these boards 1 are cut, it includes a core 4, which can be made out of various materials. In particular, this core 4 can be a wood-containing core, in particular made of HDF, MDF or of agglomerated wood, as well as it can be made of a synthetic material, even of recycled materials.

As regards the decorative layer 3 this panel 2 receives on its upper face 5, it advantageously consists of a printed decorative sheet. It should be noted that at the level of its lower face 6, this panel 2 can receive a layer of balancing coating, often called counterbalance, even a layer of a sound-insulating material.

Finally, according to the inventive method, the decorative sheet 7 is applied on the board 4 of the panel 2 by gluing, in particular by means of urea-resin glue 8.

Thus, in a surfacing unit S, glue is applied, by adequate means, on all or part of the upper face 5 of the panel 2 before applying, in particular by calendering, the decorative sheet 7.

According to the invention, the latter is previously coated, on its decorative face 9, with at least one layer of a varnish including a filler aimed at enhancing the abrasion resistance of the floor covering, which is formed by the boards 1 obtains by the method according to the invention.

Advantageously, this filler corresponds to aluminium oxide.

In a quite as advantageous way, this varnish the decorative sheet 7 is coated with defines the degree of brightness that one wants to obtain.

Thus, because of the variety of existing varnishes, it is possible to achieve a large diversity of aspects and degrees of brightness. Moreover, this solution allows avoiding the problems of expansion of the paper.

If necessary, simultaneously or within the framework of a different step, the lower face of a panel 2, can also be coated with glue, in particular urea-resin glue, in order to receive the layer of a balancing coating, or counterbalance 10. The latter can substantially be defined by a sheet of kraft paper.

Furthermore, in substitution or addition to this counterbalance 10, on this lower face 6 of the support panels 2 can be applied a layer of sound-insulating material. The latter has not been shown in the figures of the drawing.

According to the invention, the panels 2, when leaving the surfacing unit S, in particular coated with their decorative layer 3, are directly conveyed, through adequate transfer means 13, towards a cutting and machining unit 11 where they are cut into floor-covering boards 1.

In other words, at the exit of this cutting and machining unit 11 the boards 1 include, at their peripheral edge, encasing means, of the tongue-and-groove type, permitting their assembling by gluing or mechanical bonding.

It should however be noted that downstream of this cutting and machining unit 11 can be implanted a unit for applying a sound-insulating coating on the lower face of these boards 1, in the event the panels would not have been provided with same upstream.

The boards thus obtained through the method according to the invention fulfil all the criteria to be met by a floor covering. In particular, the addition of a filler, such as aluminium oxide, to the varnish the decorative sheet is previously coated with, imparts a perfect abrasion resistance to the boards, without it being necessary to use the usual stratification solution.

But, in particular, the application of the decorative sheet with glue, in particular with urea-resin glue, on the panel results into a polymerization without heat supply, without requiring any stabilization phase and authorizing the treatment of the panel directly in the cutting and machining unit for making the boards. No intermediate storage is necessary, except that, for reasons of flexibility of the operation, means 12 for constituting a buffer storage can be provided between the unit for surfacing S the panels 2 and the cutting and machining unit 11, at the level of the transfer means 13. In particular, such a buffer storage 12, shown with dashed lines in FIG. 2, allows, for example, proceeding to changing the decorative sheet 7 at the level of the surfacing unit S, without it being useful to interrupt the operation of the cutting unit 11.

Likewise, an interruption of the operation of the latter permits, through constituting the buffer storage 12, stopping the unit S for surfacing the panels 2.

Finally, by avoiding, throughout the production of the floor-covering boards or slabs, subjecting the materials to large changes in temperature, all the drawbacks, which usually result from same, are coped with.

In particular, any phenomenon of expansion of the decorative sheet is avoided, as well as the creation of stresses at the level of the material forming the core of the panels.

In this respect, the method according to the invention allows using a wider diversity of materials forming this core of the panels, compared to those usable when adopting a hot-pressing solution. In particular, heat-sensitive synthetic materials can be used, as well as materials, which can withstand only a small compression, knowing that in a calendaring process the panels are subjected to pressures, which are often lower than for example in the case of a melamine press.

Obviously, since it is not necessary to store the panels at the exit of the surfacing unit S, one saves production space.

Thus, as is obvious from the preceding description, the present invention represents a clear progress in the field of the production of floor coverings.

1. Production method for floor-covering boards or slabs from support panels coated with a decorative layer by surfacing, wherein:
glue is applied on all or part of at least one face of a support panel;
a decorative sheet is applied, in particular by calendering, on said glued face of the support panel;
said panel is cut into floor-covering boards and/or slabs.

2. Method according to claim 1, wherein glue is applied on all or part of each face of the support panel, for applying, in particular by calendering, a decorative sheet on one of the faces and a layer of a balancing coating on the opposite face.

3. Method according to claim 1, wherein urea-resin glue is used for applying glue on at least one of the faces of the support panel, in particular the face aimed at receiving the decorative sheet.

4. Method according to claim 1, wherein the decorative sheet is coated, on its decorative face, with at least one layer of varnish containing a defined filler capable of enhancing the abrasion resistance of the floor covering.

5. Method according to claim 1, wherein a buffer storage is constituted between a unit S for surfacing the panels and a cutting and machining unit for cutting these panels into floor-covering boards or slabs.

6. Method according to claim 1, wherein on the face opposite the decorative layer, a layer of sound-insulation material is applied on the panels.

7. Method according to claim 1, wherein a layer of sound-insulation material is applied on the lower face of the boards or slabs cut from the panels.

8. Plant allowing implementing the method according to claim 1, including a unit for surfacing the panels and a cutting and machining unit for cutting said surface-treated panels into floor-covering boards and/or slabs, as well as means for transferring the panels between said surfacing unit and the cutting and machining unit.

9. Plant according to claim 8, including means for constituting a buffer storage of panels at the level of the transfer means between the unit for surfacing the panels and the cutting and machining unit.

10. Floor-covering board or slab resulting from the method according to claim 1, provided, on the upper face, by application of urea-resin glue, with a decorative sheet coated at the level of its decorative face with at least one layer of varnish incorporating a filler, such as aluminum oxide, in order to enhance its abrasion resistance.
